(19) United States
(12) Patent Application Publication
(10) Pub. No.: US 2014/0360271 A1
(43) Pub. Date: Dec. 11, 2014

(54) OBJECT INFORMATION ACQUIRING APPARATUS AND METHOD OF CONTROLLING OBJECT INFORMATION ACQUIRING APPARATUS

(71) Applicant: CANON KABUSHIKI KAISHA, Tokyo (JP)

(72) Inventor: Kazuhiko Fukutani, Kyoto-shi (JP)

(73) Assignee: CANON KABUSHIKI KAISHA, Tokyo (JP)

(21) Appl. No.: 14/287,337

(22) Filed: May 27, 2014

(30) Foreign Application Priority Data
Jun. 5, 2013 (JP) 2013-119204

(51) Int. Cl. G01N 29/06

(52) U.S. Cl. CPC G01N 29/0654
USPC 73/602

(57) ABSTRACT

An object information acquiring apparatus comprises a light irradiation unit that irradiates an object with light; an acoustic probe that receives an acoustic wave generated within the object; a first data processing unit that generates a first image representing information within the object, on the basis of an acoustic wave received by the acoustic probe; a template acquisition unit that divides the first image into a plurality of regions on the basis of a spatial resolution within the image, and acquires a plurality of pieces of template data according to characteristics of each region after division; and a second data processing unit that performs deconvolution processing using corresponding template data with respect to each of the regions after division to generate a second image.

### BACKGROUND OF THE INVENTION

1. Field of the Invention

The present invention relates to an object information acquiring apparatus and a method of controlling the same, and particularly relates to a technique of acquiring information of the inside of an object with high precision.

2. Description of the Related Art

Research has been active in the medical field for optical imaging apparatuses that image information within a living body by irradiating a living body with light such as laser light and receiving and analyzing an ultrasound wave generated from inside the living body due to the light. When an object is irradiated with measurement light such as pulsed laser light, an acoustic wave is generated upon absorption of the measurement light by a living tissue within the object. By receiving and analyzing the acoustic wave (typically ultrasound wave), information relating to the optical characteristics inside the living body can be imaged. Such technique is called photoacoustic imaging (PAI).

A photoacoustic imaging apparatus can obtain the optical characteristic distribution, particularly, the initial sound pressure distribution, the light energy absorption density distribution, the absorption coefficient distribution, or the like within an object. Such information can be used for measurement of a specific substance, e.g., oxygen saturation within blood, within the object. In recent years, preclinical research on imaging of a blood vessel of small animals or clinical research on applying this principle to diagnosis for breast cancer or the like using this photoacoustic imaging technique have been active (see Non-Patent Literature 1).
Non-Patent Literature 1: “Photoacoustic imaging in biomedicine”, M. XU, L. V. Wang, Review of Scientific Instrument, 77, 041101, 2006
Non-Patent Literature 2: “Improved in vivo photoacoustic microscopy based on a virtual-detector concept”, M. Li, H. Zhang and L. V. Wang, Optocs Letters, 31 (4), 474, 2006

### SUMMARY OF THE INVENTION

Normally, in a photoacoustic imaging apparatus, an acoustic wave is received by a detection element provided to an acoustic probe, and information within an object is generated on the basis of the received acoustic wave.

Such an element that detects an acoustic wave has a characteristic that the receiving sensitivity differs depending on the angle with respect to a light absorber. This is called directivity of a detection element. A region in which energy of a generated acoustic wave can be received is called aperture width. There are cases where the resolution decreases due to limitations in the aperture width.

In this manner, it is known that the resolution upon imaging of a portion of interest changes greatly depending on the position within an object, due to the directivity of a detection element or limitation in the aperture width (see Non-Patent Literature 2). For example, in a region in which the receiving sensitivity is high and the aperture width is large, alight absorber can be imaged with high resolution. In contrast, in a region in which the receiving sensitivity is low and the aperture width is small, the light absorber appears in low resolution, i.e., as a blurry image. As a result, there has been a problem in a conventional photoacoustic imaging apparatus that the light absorber, regardless of being the same size, is imaged in different sizes depending on the position within the object, thus decreasing the diagnostic performance.

In order to solve the problem, it is necessary to provide a technique that does not change the resolution of an image, even in the case where the detection sensitivity for a light absorber differs for each region within an object.

The present invention has been made in view of such a task, and an object is to provide an object information acquiring apparatus that can appropriately correct variation in the resolution of image data.

The present invention in its one aspect provides an object information acquiring apparatus comprises a light irradiation unit that irradiates an object with light; an acoustic probe that receives an acoustic wave generated within the object; a first data processing unit that generates a first image representing information within the object, on the basis of an acoustic wave received by the acoustic probe; a template acquisition unit that divides the first image into a plurality of regions on the basis of a spatial resolution within the image, and acquires a plurality of pieces of template data according to characteristics of each region after division; and a second data processing unit that performs deconvolution processing using corresponding template data with respect to each of the regions after division to generate a second image.

The present invention in its another aspect provides a method of controlling an object information acquiring apparatus including a light irradiation unit that irradiates an object with light, and an acoustic probe that receives an acoustic wave generated within the object, the method comprises a first data processing step of generating a first image representing information within the object, on the basis of an acoustic wave received by the acoustic probe; a template acquisition step of dividing the first image into a plurality of regions on the basis of a spatial resolution within the image, and acquiring a plurality of pieces of template data according to characteristics of each region after division; and a second data processing step of performing deconvolution processing using corresponding template data with respect to each of the regions after division to generate a second image.

The present invention can provide an object information acquiring apparatus that can appropriately correct variation in the resolution of image data.

Further features of the present invention will become apparent from the following description of exemplary embodiments with reference to the attached drawings.

### BRIEF DESCRIPTION OF THE DRAWINGS

FIG. 1 is a configuration diagram of a photoacoustic measurement apparatus according to one embodiment of the present invention;

FIGS. 2A and 2B are diagrams illustrating a method of dividing an image in one embodiment of the present invention;

FIG. 3 is a diagram showing an example in which division of an image is performed and an example of a reconstructed image;

FIG. 4 is a process flowchart for a photoacoustic measurement apparatus according to one embodiment of the present invention; and

FIG. 5 is a configuration diagram of a photoacoustic measurement apparatus according to a modified example of the present invention.

### DESCRIPTION OF THE EMBODIMENTS

An embodiment of the present invention will be described below in detail with reference to the drawings. The same components are in principle denoted by the same reference numeral, and description is omitted.

A photoacoustic measurement apparatus according to this embodiment is an apparatus that images information relating to the optical characteristics within an object by irradiating the object with laser light and receiving and analyzing a photoacoustic wave generated within the object due to the laser light. The information relating to the optical characteristics is generally the initial sound pressure distribution, the light absorption energy density distribution, the absorption coefficient distribution, the concentration distribution of a substance forming a tissue such as, for example, the oxygen saturation distribution, or the like.

<System Configuration>

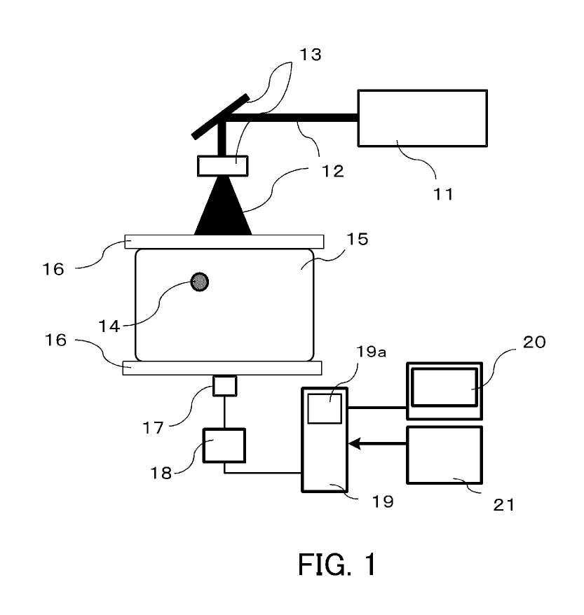

Referring to FIG. 1, the configuration of the photoacoustic measurement apparatus according to this embodiment will be described.

The photoacoustic measurement apparatus according to this embodiment includes a light source 11, an optical system 13, a holding member 16, an acoustic probe 17, a signal acquisition unit 18, a data processing unit 19, a display device 20, and an input unit 21. Although not a component of the apparatus, numeral 12 denotes pulsed light with which an object is irradiated, numeral 15 denotes the object, and numeral 14 denotes a light absorber in FIG. 1.

The respective components forming the photoacoustic measurement apparatus according to this embodiment will be described below.

<<Light Source 11>>

The light source 11 is a device that generates pulsed light for irradiation of an object. For the light source, a laser light source is preferable to obtain high power, but a light-emitting diode, flashlamp, or the like may be used instead of laser. In the case of using laser as the light source, there are various types for use such as solid-state laser, gas laser, dye laser, and semiconductor laser. The timing, waveform, intensity, and the like of irradiation are controlled by a light source control unit (not shown). The light source control unit may be integral with the light source. The light source may be integral with the photoacoustic measurement apparatus or may be provided as a separate part.

The wavelength of pulsed light is a specific wavelength for absorption by a specific constituent out of constituents forming an object, and is preferably a wavelength in which light propagates into the object. Specifically, in the case where the object is a living body, 500 nm or greater and 1200 nm or less is preferable.

In order to effectively generate a photoacoustic wave, irradiation with light needs to be in a sufficiently short period of time according to the heat characteristics of the object. In the case where the object is a living body, approximately 10 nanoseconds is suitable for the pulse width of pulsed light generated from the light source.

<<Optical System 13>>

The optical system 13 is a component that guides pulsed light generated by the light source 11 to the object 15. Specifically, the optical system 13 is an optical part configured of an optical fiber, a lens, a mirror, a lens that focuses or spreads light for a change in shape, a diffuser that diffuses light, or the like, so that an intended beam shape and light intensity distribution can be obtained. Using the optical parts, the irradiating conditions such as the irradiating shape of pulsed light, light density, or irradiating direction for an object can be set at will.

Any optical part may be used to form the optical system 13, as long as the object 15 is irradiated with an intended shape of the pulsed light 12 emitted from the light source. In terms of safety of an object and increasing the diagnosis region, light is preferably spread to a certain degree of area rather than focused with a lens.

The light source 11 and the optical system 13 are a light irradiation unit of the present invention.

<<Object 15 (Light Absorber 14)>>

The object 15 and the light absorber 14 do not form a part of the photoacoustic measurement apparatus, but will be described below. The object 15 is a target of photoacoustic measurement and typically a living body. Herein, the object is a human breast. However, the object may be a phantom simulating the characteristics of a living body. With the photoacoustic measurement apparatus according to this embodiment, a light absorber with a large light absorption coefficient that exists inside the object 15 can be imaged. In the case where the object is a living body, the light absorber is specifically water, lipid, melanin, collagen, protein, oxyhemoglobin, deoxyhemoglobin, or the like.

In the case where the object is a phantom, a substance simulating the optical characteristics of the substance described above is encapsulated inside as the light absorber. By imaging a light absorber inside a living body, the photoacoustic measurement apparatus according to this embodiment can perform contrast enhancement for a blood vessel, diagnosis such as tumor or vascular disease of a human or animal, follow-up of a chemical treatment, or the like.

<<Holding Member 16>>

The holding member 16 is a plate-shaped member that holds the object 15. Two holding members are arranged to face each other, and an object can be held by changing the interval. The holding member 16 is preferably of a material having high transmissivity and low attenuation characteristics with respect to light for irradiation from the light source and an acoustic wave generated within an object. Examples include a resin member of polymethylpentene. Note that a plastic material such as polyethylene terephthalate (PET) is also acceptable, since attenuation of an acoustic wave can be ignored in the case where the holding member is thin.

<<Acoustic Probe 17>>

The acoustic probe 17 is a component that converts an acoustic wave generated inside the object 15 to an analog electrical signal. The acoustic probe is also called simply a probe, an acoustic detector, or a transducer. An acoustic wave in the present invention is typically an ultrasound wave and includes elastic waves called a sound wave, an ultrasound wave, a photoacoustic wave, and a light-induced ultrasound wave. The acoustic probe 17 may be formed of a single acoustic probe or may be formed of a plurality of acoustic probes.

The acoustic probe 17 is preferably high in sensitivity and broad in frequency band. Specific examples include those using a piezoelectric ceramic (PZT), a polyvinylidene fluoride resin (PVDF), a capacitive micromachined ultrasound transducer (CMUT), or a Fabry-Perot interferometer. Note that the examples given herein are not limiting. Anything that fulfills the function as a probe is acceptable.

In the acoustic probe 17, a plurality of reception elements may be arranged one-dimensionally or two-dimensionally. When a multidimensional array element is used, an acoustic wave can be received in a plurality of places simultaneously. Therefore, the measurement time can be shortened, and the influence such as the vibration of an object can be reduced. In the case where the probe is smaller than an object, the probe may scan a plurality of positions to receive acoustic waves.

<<Signal Acquisition Unit 18>>

The signal acquisition unit 18 is a component with which an electrical signal obtained by the acoustic probe 17 is amplified and converted to a digital signal. The signal acquisition unit 18 is typically configured of an amplifier, an A/D converter, a field-programmable gate array (FPGA) chip, and the like.

In the case where a plurality of detection signals are obtained from the probe, it is preferable that processing of a plurality of signals be possible simultaneously. Accordingly, the time until an image is formed can be shortened.

In this specification, “detection signal” is a concept that includes an analog signal acquired from the acoustic probe 17 and a digital signal after A/D conversion. The detection signal is also called a photoacoustic signal.

<<Data Processing Unit 19>>

The data processing unit 19 is a component that generates image data (performs image reconstruction) by processing a digital signal obtained by the signal acquisition unit 18, and is first and second data processing units and a template acquisition unit of the present invention. For the data processing unit 19, a workstation or the like is typically used to perform processing of reconstructing an image with software. The software is configured of, for example, a signal processing module that performs noise reduction processing for a receive signal, an image reconstruction module that performs image reconstruction using a signal processed in the signal processing module, and an image processing module that process a reconstructed image.

The data processing unit 19 includes a memory 19a that stores template data that is a feature of the present invention. The template data will be described later.

The signal acquisition unit 18 and the data processing unit 19 may be integrated. The image data may be generated not by software processing but by hardware processing.

<<Other Components>>

Other components will be described.

A display device 20 is a device that displays image data generated by the data processing unit 19, and is typically a liquid crystal display or the like. The display device 20 does not necessarily need to be a part of the photoacoustic measurement apparatus and may be connected externally.

The input unit 21 is a component that acquires characteristic information of an object from an operator, and is typically a keyboard, a touchscreen integral with the display device 20, or the like. The characteristic information of an object is the sound speed or attenuation coefficient within the object or data for calculation thereof such as age, weight, or height of the object. The input unit 21 may be any device as long as the characteristic information of an object to be transmitted to the data processing unit 19 can be acquired. The input unit 21 is a characteristic acquisition unit of the present invention.

<Overview of Image Formation Processing>

Next, an overview of processing performed by the photoacoustic measurement apparatus according to this embodiment will be described.

First, the object 15 is irradiated with the pulsed light 12 emitted from the light source 11 via the optical system 13. When a part of light energy propagated inside an object is absorbed by a light absorber such as a blood vessel including a high level of hemoglobin, an acoustic wave is generated from the light absorber due to thermal expansion. An acoustic wave generated within the object is received by the acoustic probe 17 and processed by the signal acquisition unit 18 and the data processing unit 19. The analysis result is converted to a first image (optical characteristic value information) representing the characteristic information within the object.

When an image is reconstructed with such a method, the spatial resolution changes depending on the position within the image (i.e., position within the object) due to the difference in the directivity of a detection element or the aperture width of the acoustic probe.

How the spatial resolution changes differs greatly depending on the arrangement of a measurement system.

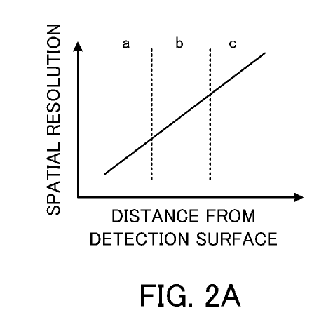

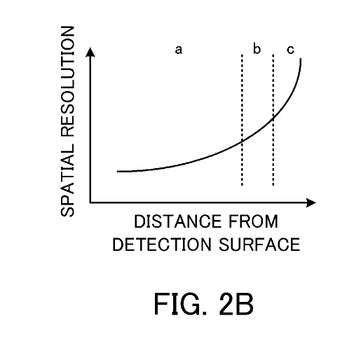

For example, consider a case where an acoustic wave is received by a parallel flat-plate system, i.e., in a position such that the acoustic probe is parallel to the surface of the object, as shown in FIG. 1. In such a case, the spatial resolution of the reconstructed image in the planar direction (probe surface direction) is higher (i.e., the value is smaller) in a region that is closer to the detection surface of the acoustic probe, as in FIG. 2A. Since the detection sensitivity for an acoustic wave decreases when the distance increases from the detection surface of the acoustic probe, the spatial resolution is lower (i.e., the value is greater) when a target portion is in a deeper part of the object.

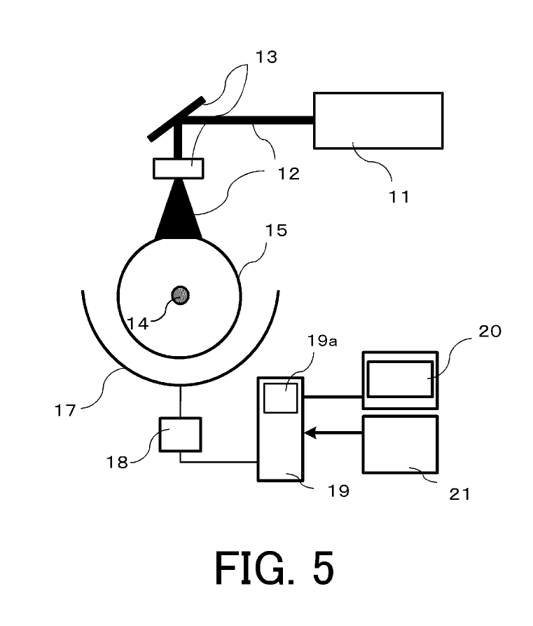

In the case where the measurement system is such that a half-sphere-shaped acoustic probe surrounds an object and an acoustic wave is received in a plurality of positions at approximately the same distance from the object surface as in FIG. 5, the spatial resolution of a reconstructed image is higher in a region that is closer to the center of the object as in FIG. 2B. The center of the object is a point (position of the light absorber 14 in FIG. 5) where the distances from the acoustic probe are the same. This is because the sensitivity of an acoustic element forming the acoustic probe is highest in a direction that the acoustic element is facing. The overall detection sensitivity for an acoustic wave is highest in a center portion of the object since each acoustic element is facing the center of the object, although there is a distance from the acoustic probe. Since the detection sensitivity for an acoustic wave decreases when the distance increases from the center portion of the object, the spatial resolution decreases as the distance of the target portion from the center of the object increases.

When the spatial resolution decreases, the light absorber is imaged in a more blurry state.

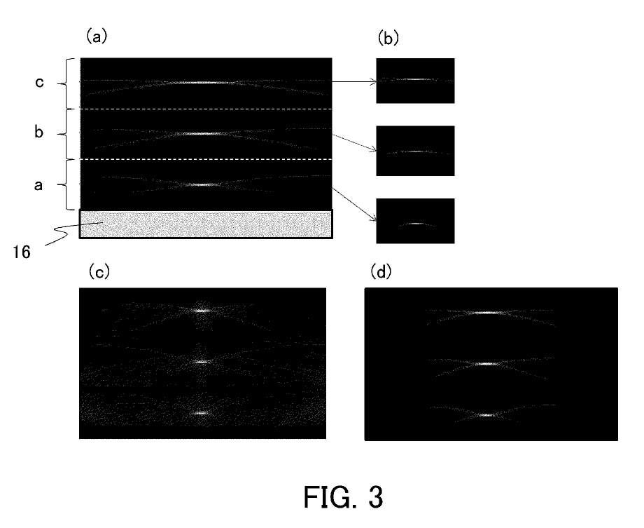

FIG. 3(a) is an example in which three light absorbers of the same size that are arranged respectively at different depths are imaged. Numeral 16 denotes the holding member that holds the object, and the acoustic probe 17 is adjacent to the holding member 16.

The three white contrast images show dot-shaped light absorbers of the same size. Since the spatial resolution decreases as the distance increases from the acoustic probe 17, images of different sizes are formed in FIG. 3(a) regardless of the three light absorbers respectively being the same size.

Thus, in the photoacoustic measurement apparatus according to this embodiment, an approach is taken in order to correct the decreased spatial resolution by executing deconvolution processing with respect to the first image using the template data stored in the memory 19a to generate a second image.

Note that, when the deconvolution processing is performed with the same template data applied with respect to an image with partially low spatial resolution, the image quality in a region with high spatial resolution also changes. Thus, the data processing unit 19 divides the first image into a plurality of regions and carries out the deconvolution processing using the template data suitable with respect to each of the plurality of divided regions. Accordingly, variation in the resolution can be corrected over the entire target region, and clear image data can be obtained. The details of the template data will be described later.

<Details of Image Formation Processing>

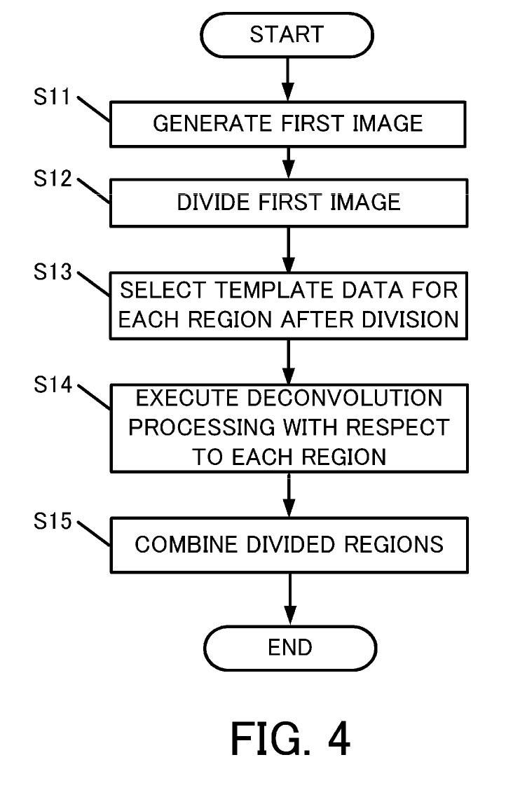

Next, the specific content of the image formation processing will be described. Herein, processing of reducing variation in the resolution within an image under a measurement condition that the spatial resolution decreases as the distance increases from the acoustic probe in particular will be described with reference to FIG. 4 that is a process flowchart.

Step S11 is a step of reconstructing information relating to the optical characteristic value of the inside of an object from an acquired acoustic wave to generate a first image.

In this step, the first image relating to the optical characteristic value information of the inside of the object is generated on the basis of a detection signal. The optical characteristic value information is specifically the initial sound pressure distribution, the light absorption energy density distribution, or the absorption coefficient distribution. For generation of the image, various conventional image reconstruction algorithms can be used. For example, a back projection method, a Fourier conversion method, a time reversal method, or the like described in Non-Patent Literature 1 can be used.

Step S12 is a step of dividing the first image obtained in step S11 into a plurality of regions according to the spatial resolution of the image. The spatial resolution of the image is estimated on the basis of the position within the image.

For example, in the case where the spatial resolution in the planar direction of the image decreases as the distance increases from the detection surface of the acoustic probe as in FIG. 2A, the image is divided on the basis of the depth position within the object. For example, in the case where the first image corresponds to the depth position of 0 to 30 mm and the spatial resolution changes linearly, the first image is divided into three regions (a, b, and c) at 10 mm intervals. White dotted lines in FIG. 3(a) show the boundary at which division is performed.

In the case where the spatial resolution in the planar direction of the image decreases as the distance increases from the center of the object as in FIG. 2B, it suffices to divide the image on the basis of the distance from the center of the object.

Although the first image has been divided into equal widths in this example, the divided widths do not necessarily need to be equal since the change in spatial resolution differs depending on the directivity and arrangement of the probe. For example, in the case where the spatial resolution changes non-linearly as in FIG. 2B, it is preferable that the change rates of spatial resolution be equal in regions after division.

The width upon performing division depends on the obtained spatial resolution, but is preferably approximately several tens of micrometers to several millimeters. Each region after division preferably includes an overlap region to some degree.

Step S13 is a step of selecting the corresponding template data for each region divided in step S12.

The template data will be described. The template data is data representing a point spread function (PSF) for performing the deconvolution processing. The PSF is a point distribution intensity function representing the input-output characteristics of a signal (response characteristics of the measurement system herein).

The input-output characteristics change depending on conditions such as the characteristics of the object itself or the directivity or aperture width of the detection element, and may cause the spatial resolution to decrease. That is, by selecting, for each divided region, the PSF simulating the input-output characteristics of the region and performing the deconvolution processing, the deteriorated image quality can be restored.

In this embodiment, PSFs corresponding to various conditions are stored as the template data the memory 19a. The PSFs are obtained by performing simulation of a photoacoustic wave generated from an arbitrary point sound source within a region divided in advance, on the basis of the system characteristic such as the aperture width or directivity of a detection element. That is, the corresponding PSF for each spatial resolution is stored in the memory 19a in advance, and the template data suitable for each region is acquired from the plurality of pieces of template data in step S13.

For example, in the case where the image is divided into three regions as in FIG. 3(a), the template data is selected according to the spatial resolution of each image. FIG. 3(b) shows one example of the template data corresponding to the three divided regions.

One specific example of a selecting method will be shown. For example, in the case where the spatial resolution of a divided region in the planar direction is estimated to be distributed in a range of 1.0 to 1.3 mm, the PSF corresponding to the intermediate resolution (1.15 mm herein) is selected.

Step S14 is a step of performing deconvolution for each region using the template data selected in step S13.

As described above, the deconvolution processing is performed using the template data corresponding to the spatial resolution of each region. For a method of the deconvolution processing, Wiener deconvolution that has been conventionally used, deconvolution based on optimization processing for an objective function, or the like can be used. If the precision is insufficient with the template data selected in step S13, it may be such that the template data is considered an initial value and processing is performed while modifying the template data. Such an approach is called blind deconvolution.

Step S15 is a step of integrating the divided regions into one image.

The regions divided in step S12 are combined and restored to one piece of image data. For combining of the image, the divided regions may simply be connected, or, in the case where there is an overlapping region in the respective regions, averaging processing (e.g., simple averaging or weighted averaging) may be performed with respect to the overlapping region. Accordingly, the images are joined smoothly.

FIG. 3(c) is the result of performing the deconvolution processing using the template data shown in FIG. 3(b) with respect to the respective divided regions and combining the obtained images. By performing deconvolution of an image using template data according to the characteristics of each region in this manner, an image in which variation in the resolution is reduced can be obtained.

In this manner, with the photoacoustic measurement apparatus according to this embodiment, variation in the resolution for each position within an image due to device characteristics such as the aperture width or the directivity of a detection element can be reduced, and the diagnosis performance can be improved.

Although the template data is selected from the plurality of PSFs stored in advance in this embodiment, it may be such that information relating to the characteristics of an object is acquired from the input unit 21 and template data is generated each time using the information.

In this case, processing (step S12a (not shown)) of generating the template data according to the characteristics of the object is executed after execution of step S12. Specifically, characteristic information of the object (e.g., sound speed or attenuation coefficient within the object) is acquired, and simulation of a photoacoustic wave generated from a point sound source within the divided region is performed using the characteristic information. Accordingly, the input-output characteristics of the region can be acquired, and a corresponding PSF can be generated. By using this method, a precise PSF according to the characteristics of a target region can be used as the template data.

### Example 1

The effect of the photoacoustic measurement apparatus according to the embodiment of the present invention has been checked with an experiment. In this example, a Ti:Sa laser system for frequency-doubled YAG laser excitation was used as the light source 11. The laser system can irradiate an object with light having a wavelength of 700 to 900 nm. Using an optical system formed of a mirror, a beam expander, and the like, an object was irradiated with laser light that has been spread to approximately 1 cm in radius.

For the acoustic probe 17, a two-dimensional array piezoprobe with 18×18 elements was used. The signal acquisition unit 18 has a function with which signals of all 324 channels acquired from the acoustic probe 17 are received simultaneously from the acoustic probe 17, amplified, subjected to digital conversion, and then transferred to the data processing unit 19. In this example, a PC was used as the data processing unit. The memory 19a is a storage medium built in the PC.

The object 15 is a phantom simulating a living body. Intralipid of 1% and diluted ink were solidified with agar into a cuboid for use. Within the phantom, three pieces of wire-shaped black rubber with a diameter of 0.3 mm were embedded as the light absorber. The black rubber was arranged in positions where the depths are respectively 5 mm, 15 mm, and 25 mm from the probe surface so as to be parallel to the detection surface of the acoustic probe.

First, the phantom was irradiated with pulsed light, and a signal generated on the basis of an acoustic wave received by the acoustic probe 17 was stored in the PC. Next, after performing noise processing with respect to the digitalized signal, reconstruction of an image and correction of the light amount distribution was performed as described in step S11 to obtain an image (first image) representing the distribution of the absorption coefficient within the phantom. In the image obtained herein, the spatial resolution decreased as the distance increased from the detection surface of the acoustic probe as in FIG. 2A.

Next, the image was divided into three regions according to the spatial resolution as described in step S12, and the template data suitable for each region was selected as described in step S13. The template data stored in the memory 19a is a plurality of PSFs obtained by performing simulation in advance and reconstruction for a detection signal, in consideration of the sound speed or the attenuation coefficient of an acoustic wave within the phantom, the aperture width that is the device characteristics, and the probe characteristics of the directivity or bandwidth.

Next, the deconvolution processing was performed with respect to each divided region as described in step S14. Herein, the blind convolution method using the selected template data as an initial value was used. Then, the respective images after processing were combined to obtain one image. The image obtained as a result is FIG. 3(c).

For comparison, the result of deconvolution of the entire image with one piece of template data without dividing the image is shown in FIG. 3(d). In FIG. 3(c), the light absorbers of the same size within a measurement target region are imaged in approximately the same size. That is, the spatial resolution within the reconstructed image is corrected to be approximately constant regardless of the position within the object. In FIG. 3(d), the overall resolution is improved compared to the image (FIG. 3(a)) before deconvolution, but the light absorbers of the same size are imaged in different sizes depending on the location. That is, variation in the resolution is not resolved.

From the results above, it was confirmed that the photoacoustic measurement apparatus according to this embodiment can generate an image with a small change in resolution by performing deconvolution processing with PSFs suitable respectively for a plurality of regions within the image.

### Example 2

In Example 1, a plurality of pieces of template data were stored, and the template data for use was selected according to the spatial resolution. In contrast, Example 2 is an example in which simulation of a photoacoustic wave is performed for operation for a PSF and the template data is generated each time.

The configuration of the photoacoustic measurement apparatus according to Example 2 and the phantom used as the object are the same as in Example 1.

First, a receive signal was reconstructed with the back projection method to generate a first image (step S11). Then, according to the spatial resolution, the first image was divided into three regions (step S12). In this example, image division was performed with a similar size as in Example 1, but an overlapping region was provided in an end portion of each region.

Next, 1500 m/s that is the sound speed within the phantom and 0.5 dB/(MHz/cm) that is the attenuation coefficient were input to a PC that is the data processing unit 19 from a keyboard that is the input unit 21 to perform a photoacoustic simulation of a point sound source using a Green's function. By reconstructing the simulation result, a PSF for the center of each region after division was generated and stored in a memory as template data (step S12a).

Next, the corresponding template data with respect to each divided region was selected (step S13), and deconvolution processing was performed using a Weiner convolution method with respect to each region (step S14). Further, averaging of the overlapping region was performed to generate an image in which the respective regions are combined (step S15).

The image obtained as a result was an image similar to FIG. 3(c). That is, light absorbers of the same size within a measurement target region were imaged in approximately the same size regardless of the position within the object, and it was confirmed that an effect similar to that of Example 1 can be obtained.

### Example 3

In Examples 1 and 2, the acoustic probe was arranged to be parallel to the object surface. In contrast, Example 3 is an example using a half-sphere-shaped acoustic probe that is arranged to surround an object.

The configuration of a photoacoustic measurement apparatus according to Example 3 is shown in FIG. 5. The basic configuration of the photoacoustic measurement apparatus according to this example is similar to that of Example 1, and only the shape of the acoustic probe 17 differs. The acoustic probe 17 in this example has a half-sphere cup shape, and has a structure such that an acoustic wave can be received from various directions.

In Example 3, a sphere-shaped phantom was used as the object. Inside the phantom, three sphere-shaped light absorbers with a diameter of 2 mm were embedded along a direction away from the center of the phantom. For the light absorber, solidified blood was used.

First, a receive signal was reconstructed with the back projection method, and then the light amount was corrected to generate a first image (step S11). In the first image obtained herein, the spatial resolution decreased as the distance increased from the center of the phantom.

Next, according to the spatial resolution within the image, the first image was divided into three regions (step S12). Herein, division was into three concentric regions of a center portion, a surrounding portion, and a further surrounding portion of the object. In an end portion of each region, an overlapping region was provided.

Next, 1500 m/s that is the sound speed within the phantom and 0.5 dB/(MHz/cm) that is the attenuation coefficient were input to a PC that is the data processing unit 19 from a touchscreen that is the input unit 21 to perform a photoacoustic simulation of a point sound source using a Green's function. By reconstructing the simulation result, typical PSFs corresponding to the respective regions after division were generated and stored in a memory as a plurality of pieces of template data (step S12a).

Next, the corresponding template data with respect to each divided region was selected (step S13), and deconvolution processing was performed with respect to each region (step S14).

Herein, a deconvolution method of optimizing an intended image under a conditions that the square error for data resulting from convolution of the template data with respect to the intended image and image data of each region is minimum and is sparse for the intended image. Further, averaging of the overlapping region was performed to generate an image in which the respective regions are combined (step S15).

As a result, an image with a small change in resolution was obtained in a similar manner to other examples. That is, the light absorbers of the same size within a measurement target region were imaged in approximately the same size regardless of the position, and it was confirmed that an effect similar to those of other examples can be obtained even in the case where the spatial resolution deteriorates according to the distance from the center of the object.

Further, in Example 3, the wavelength of light for irradiation of the object is switched between two patterns of 756 nm and 797 nm to acquire the absorption coefficient distributions, and the difference thereof was used to calculate the oxygen saturation. As a result, a change in the value of oxygen saturation before and after the deconvolution processing was not confirmed. Thus, it was confirmed that performing the deconvolution processing does not influence a composition analysis of oxygen saturation or the like that is one feature of photoacoustic imaging.

### Modified Example

The embodiment has been described as an example to illustrate the present invention. The present invention may be carried out with an appropriate change or combination without departing from the gist of the invention.

For example, the present invention may be carried out as a method of controlling an object information acquiring apparatus that includes at least a part of processing described above. The processing or component may be realized in any combination as long as a technical inconsistency does not occur.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-119204, filed on Jun. 5, 2013, which is hereby incorporated by reference herein in its entirety.

What is claimed is:

1. An object information acquiring apparatus comprising:
a light irradiation unit that irradiates an object with light;
an acoustic probe that receives an acoustic wave generated within the object;
a first data processing unit that generates a first image representing information within the object, on the basis of an acoustic wave received by the acoustic probe;
a template acquisition unit that divides the first image into a plurality of regions on the basis of a spatial resolution within the image, and acquires a plurality of pieces of template data according to characteristics of each region after division; and
a second data processing unit that performs deconvolution processing using corresponding template data with respect to each of the regions after division to generate a second image.

2. The object information acquiring apparatus according to claim 1, wherein the template data is a point spread function representing response characteristics of a measurement system with respect to an acoustic wave from a corresponding region.

3. The object information acquiring apparatus according to claim 1, wherein the template acquisition unit estimates a spatial resolution within the image on the basis of a distance from the acoustic probe.

4. The object information acquiring apparatus according to claim 3, wherein the acoustic probe receives the acoustic wave in a plurality of positions parallel to a surface of the object, and
the template acquisition unit estimates that the spatial resolution is higher in a region located at a shorter distance from the acoustic probe.

5. The object information acquiring apparatus according to claim 3, wherein the acoustic probe receives the acoustic wave in a plurality of positions at approximately the same distance from a surface of the object, and
the template acquisition unit estimates that the spatial resolution is higher in a region that is closer to a point where distances from the plurality of positions are the same.

6. The object information acquiring apparatus according to claim 1, further comprising a characteristic acquisition unit that acquires characteristic information of the object,
wherein the template acquisition unit acquires the template data further according to the acquired characteristic information of the object.

7. The object information acquiring apparatus according to claim 6, wherein the characteristic information of the object is at least one of a sound speed and an attenuation coefficient within the object.

8. A method of controlling an object information acquiring apparatus including a light irradiation unit that irradiates an object with light, and an acoustic probe that receives an acoustic wave generated within the object, the method comprising:
a first data processing step of generating a first image representing information within the object, on the basis of an acoustic wave received by the acoustic probe;
a template acquisition step of dividing the first image into a plurality of regions on the basis of a spatial resolution within the image, and acquiring a plurality of pieces of template data according to characteristics of each region after division; and
a second data processing step of performing deconvolution processing using corresponding template data with respect to each of the regions after division to generate a second image.

9. The method of controlling an object information acquiring apparatus according to claim 8, wherein the template data is a point spread function representing response characteristics of a measurement system with respect to an acoustic wave from a corresponding region.

10. The method of controlling an object information acquiring apparatus according to claim 8, wherein a spatial resolution within the image is estimated on the basis of a distance from the acoustic probe in the template acquisition step.

11. The method of controlling an object information acquiring apparatus according to claim 10, wherein the acoustic probe receives the acoustic wave in a plurality of positions parallel to a surface of the object, and
the spatial resolution is estimated to be higher in a region located at a shorter distance from the acoustic probe in the template acquisition step.

12. The method of controlling an object information acquiring apparatus according to claim 10, wherein the acoustic probe receives the acoustic wave in a plurality of positions at approximately the same distance from a surface of the object, and
the spatial resolution is estimated to be higher in a region that is closer to a point where distances from the plurality of positions are the same in the template acquisition step.

13. The method of controlling an object information acquiring apparatus according to claim 8, further comprising a characteristic acquisition step of acquiring characteristic information of the object,
wherein the template data is acquired further according to the acquired characteristic information of the object in the template acquisition step.

14. The method of controlling an object information acquiring apparatus according to claim 13, wherein the characteristic information of the object is at least one of a sound speed and an attenuation coefficient within the object.
